(19) United States
(12) Patent Application Publication
(10) Pub. No.: US 2004/0216566 A1
(43) Pub. Date: Nov. 4, 2004

(54) Tool provided with conspicuous identification of specification thereof

(76) Inventor: Leo Shih, Taichung (TW)

Correspondence Address: LAW OFFICE OF LIAUH & ASSOC., 4224 WAIALAE AVE, STE 5-388, HONOLULU, HI, 96816

(21) Appl. No.: 10/427,587

(22) Filed: Apr. 30, 2003

(51) Int. Cl. B25B 13/02

(52) U.S. Cl. 81/119; 81/121.1

(57) ABSTRACT

A tool is provided in an outer surface with a first identification device and a second identification device disposed on the first identification device. The first identification device is used to associate the tool with the metric or British system in terms of specification. The second identification device is used to print thereon the specification of the tool.

### FIELD OF THE INVENTION

The present invention relates generally to a tool, and more particularly to a means by which the identification of the specification of the tool can be easily attained by an operator of the tool, with the means being an integral part of the tool.

### BACKGROUND OF THE INVENTION

A power-driven socket wrench is generally provided with a series of sockets various in specification. The sockets are orderly arranged in a tool box; nevertheless they can not be identified with ease and speed as to their specifications, thereby undermining the work efficiency of an operator of the socket wrench.

As shown in FIG. 1, the Taiwan Patent Serial No.77210372 discloses means by which two groups of wrench sockets 10 and 11 are identified as to their specifications in terms of the metric system and the British system. The first socket 10 has a size specification of “22” according to the metric system, while the second socket 11 has a size specification of “7/8” inch according to the British system. The first socket 10 is provided in the outer wall with an annular groove 101 in which a colored tape 102 is disposed. In another words, a series of the first sockets 10 are provided with the colored tape 102 indicative of the metric system. Similarly, a series of the second sockets 11 are provided with a colored tape 112 which is disposed in an annular groove 111 and is different in color from the colored tape 102 of the first sockets 10. The colored tape 112 is indicative of the British system.

The colored tapes 102 of the first sockets 10 are different in width in accordance with the size specification of the sockets 10. Similarly, the colored tapes 112 of the second sockets 11 are different in width in accordance with the size specification. Such an identification method as described above is imprecise at best.

As shown in FIG. 2, the Taiwan Patent Serial No.77210372A01 discloses two wrench sockets 12 and 13. The first socket 12 is provided in the outer wall with a colored tape 121 indicative of the metric system, and another colored tape 122 which is narrower than the colored tape 121 and is identical or different in color from the colored tape 121. In another words, the tape 122 is used to identify the even-numbered size or odd-numbered size of the sockets 12, with the sockets 12 having the even-numbered sizes being provided with the tapes 122 which are identical in color. Meanwhile, the sockets 12 with the odd-numbered size are provided with the tapes 122 which are different in color from the even-numbered tape 122. Similarly, the second sockets 13 are provided with a system-identifying tape 131 and another tape 132 for identifying the odd-numbered or even-numbered size of the sockets 13. Such an identification method as described above is confusing at best and is of a little help to a user of the sockets.

As shown in FIG. 3, the Taiwan Patent Serial No.77210372A02 discloses two groups of wrench sockets 14 and 15, which are respectively provided with an identification ring 141, 151. These identification rings 141 and 151 are identical in function to the prior art which was described above with reference to FIG. 1, with the difference being that these rings 141 and 151 are projected from the outer wall of the sockets 14 and 15. Accordingly, they have deficiencies in common.

### SUMMARY OF THE INVENTION

It is the primary objective of the present invention to provide a tool with a first identification device, and a second identification device which is disposed on the first identification device and is different in color from the first identification device. The first identification device is used to identify the tool with the metric system or British system by which a specification of the tool is expressed. The second identification device is used to specify the specification of the tool, which is printed on the second identification device.

It is another objective of the present invention to provide a tool with a first identification device and a second identification device which forms a background surface of the first identification device. The first identification device is used to associate the tool with the metric or British system by which a specification of the tool is expressed. The second identification device is used to specify the specification of the tool, with the specification existing in a hollow form in the second identification device.

It is still another objective of the present invention to provide a tool with a first identification device and a second identification device. The first identification device is used to associate the tool with the metric or British system by which a specification of the tool is expressed. The second identification device is used to specify the specification of the tool, with the specification being printed on the second identification device such that the rest of the second identification device is hollowed.

It is still another objective of the present invention to provide a tool with a first identification device and a second identification device. The first identification device is used to associate the tool with the metric or British system by which a specification of the tool is expressed. The second identification device is used to specify the specification of the tool and to show thereon a logo.

The features of the present invention will be more readily understood upon a thoughtful deliberation of the following detailed description of the preferred embodiments of the present invention with reference to the accompanying drawings.

### BRIEF DESCRIPTION OF THE DRAWINGS

FIG. 1 shows a schematic view of a first prior art.

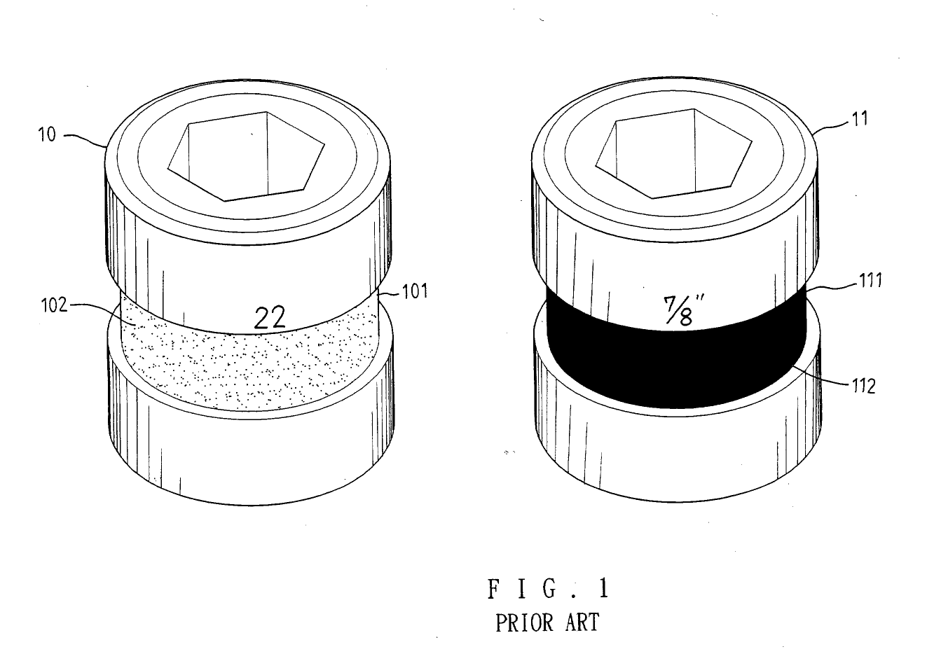

FIG. 2 shows a schematic view of a second prior art.

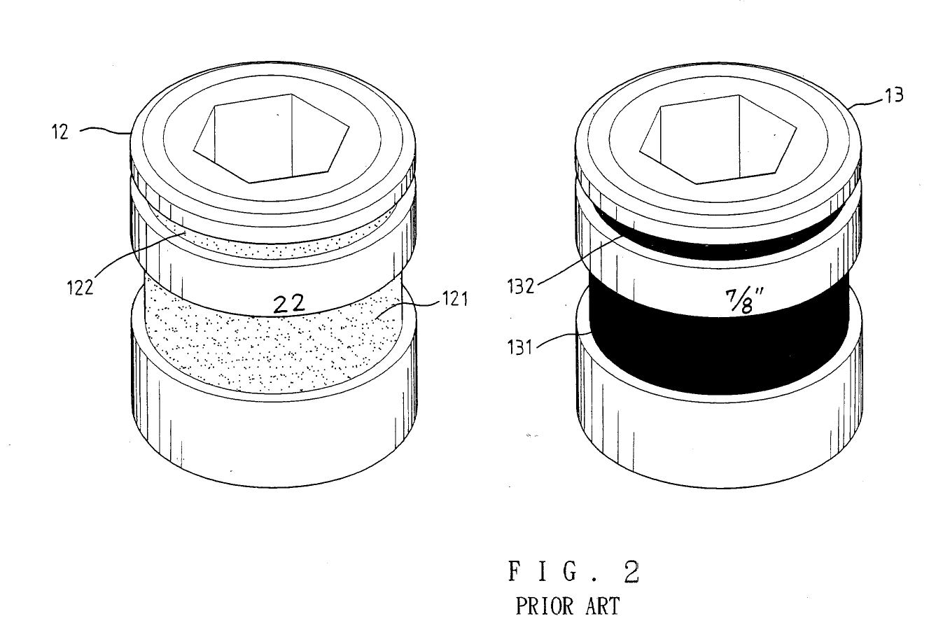

FIG. 3 shows a schematic view of a third prior art.

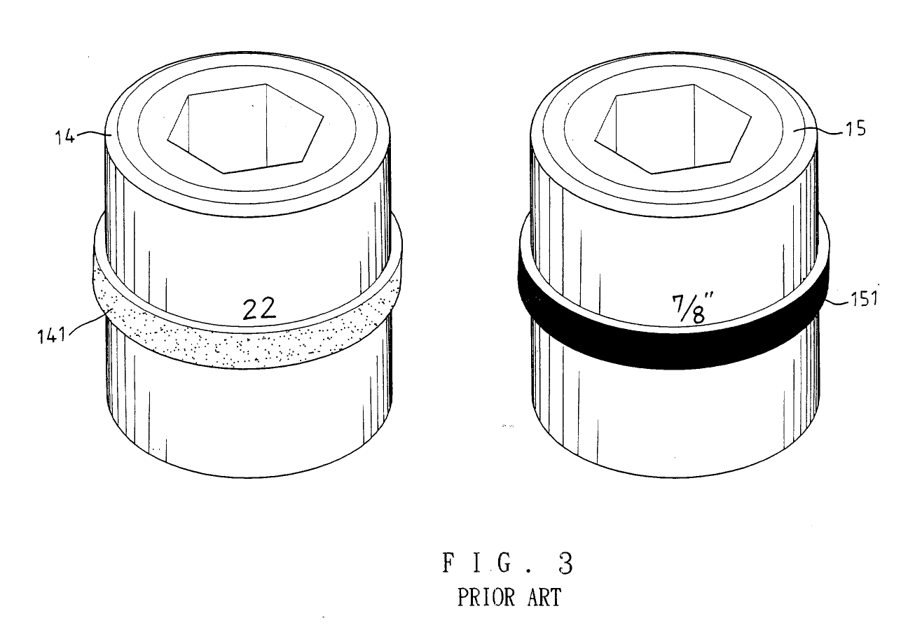

FIG. 4 shows a schematic view of a first preferred embodiment of the present invention.

FIG. 5 shows two enlarged views of two portions indicated respectively by a circle “A” and a circle “B” of FIG. 4.

FIG. 6 shows a schematic view of a second preferred embodiment of the present invention.

FIG. 7 shows a schematic view of a third preferred embodiment of the present invention.

FIG. 8 shows two enlarged views of two portions indicated respectively by a circle “C” and a circle “D” of FIG. 7.

FIG. 9 shows a schematic view of a fourth preferred embodiment of the present invention.

FIG. 10 shows a schematic view of a fifth preferred embodiment of the present invention.

FIG. 11 shows two enlarged view of two portions indicated respectively by a circle “E” and a circle “F” of FIG. 10.

FIG. 12 shows a schematic view of a sixth preferred embodiment of the present invention.

FIG. 13 shows a schematic view of a seventh preferred embodiment of the present invention.

FIG. 14 shows two enlarged views of two portions indicated respectively by a circle “G” and a circle “H” of FIG. 13.

FIG. 15 shows a schematic view of an eighth preferred embodiment of the present invention.

FIG. 16 shows two enlarged views of two portions indicated respectively by a circle “I” and a circle “J” of FIG. 15.

FIG. 17 shows a schematic view of a ninth preferred embodiment of the present invention.

FIG. 18 shows an enlarged view of a circle “K” portion of FIG. 17.

### DETAILED DESCRIPTION OF THE PREFERRED EMBODIMENTS

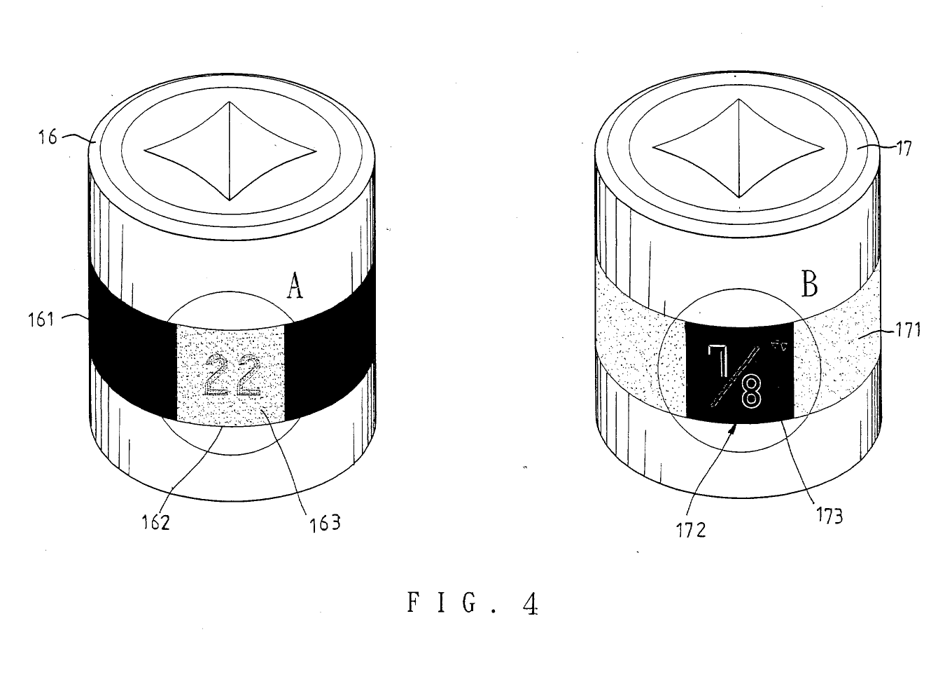

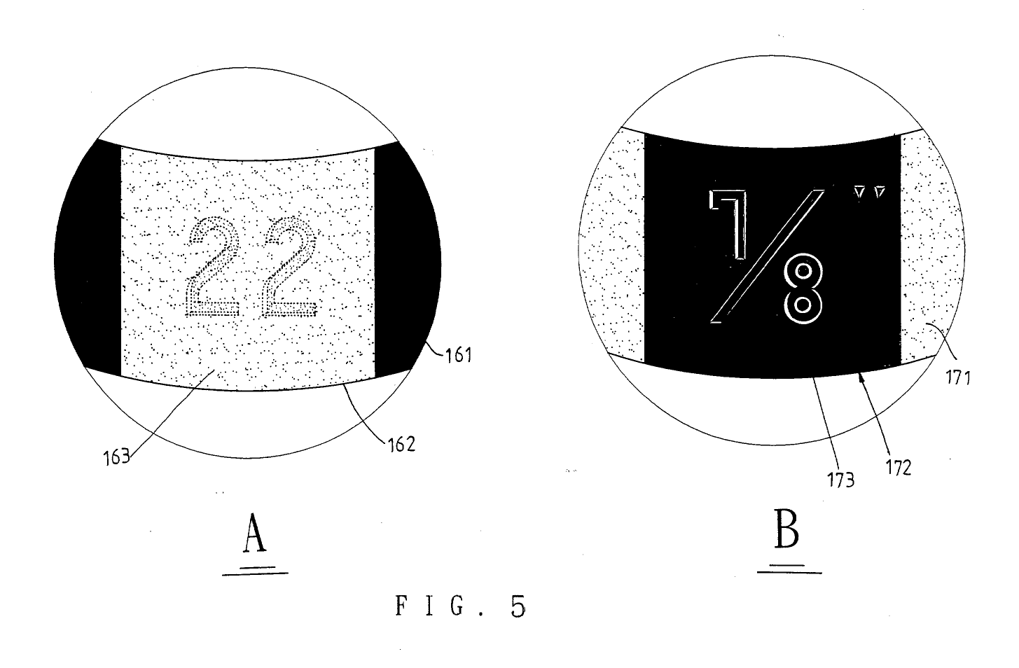

As shown in FIGS. 4 and 5, the present invention comprises a series of wrench sockets 16 (only one of them is shown in the drawing) and a series of wrench sockets 17 (only one of them is shown in the drawing). The socket 16 is provided with a first identification device 161 and a second identification device 163 which is disposed in an area 162 of the first identification device 161. The first identification device 161 has a color indicative of the metric system by which a specification, such as size “22”, of the socket 16 is expressed. The second identification device 163 is different in color from the first identification device 161 and is used for printing thereon the metric system specification of the socket 16. All of the sockets 16 are associated with the metric system in terms of specification. The socket 17 is similarly provided with a first identification device 171 and a second identification device 173 which is disposed on an area 172 of the first identification device 171. The first identification device 171 has a color which is different from the color of the sockets 16 and is indicative of the British system by which a specification, such as size of 7/8 inch, of the sockets 17 is expressed. The second identification device 173 is different in color from the first identification device 171 and is used to print thereon the British system specification of the sockets 17. As the sockets 16 and 17 are arranged in a tool box, they can be easily identified by the color of the first identification device in terms of the metric or British system.

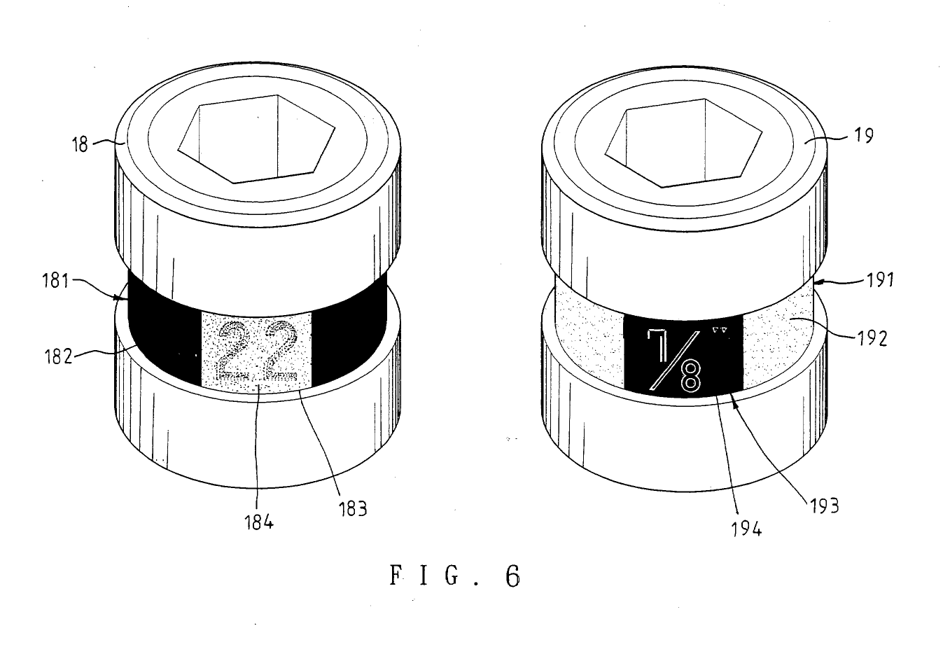

As shown in FIG. 6, a first identification device 182 of a metric system socket 18 is disposed in an annular groove 181 of the outer wall of the socket 18. A second identification device 184 is disposed on an area 183 of the first identification device 182. Similarly, a first identification device 192 of a British system socket 19 is disposed in an annular groove 191 of the outer wall of the socket 19. A second identification device 194 is disposed on an area 193 of the first identification device 182.

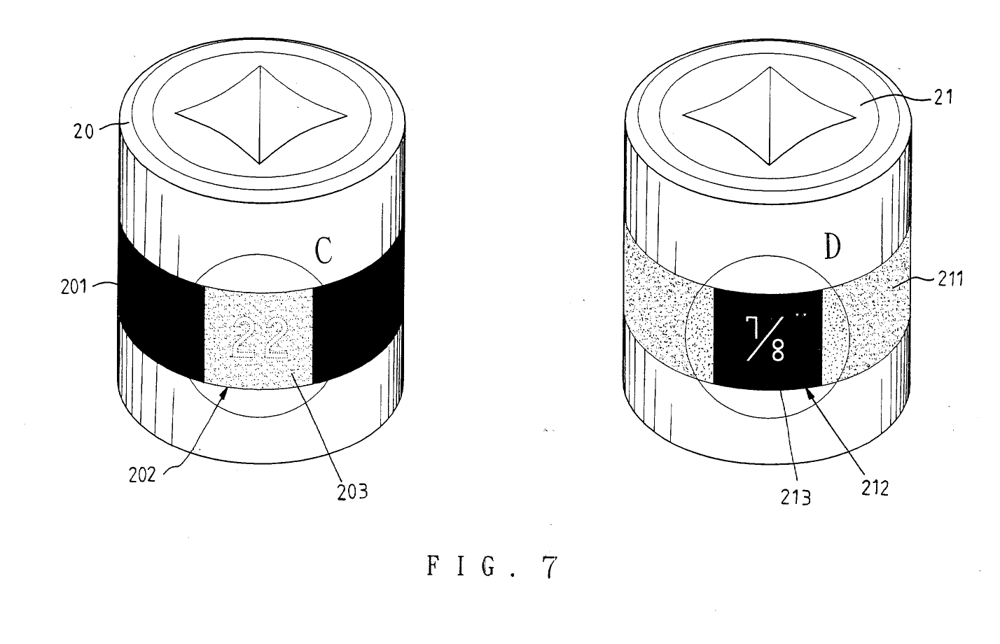

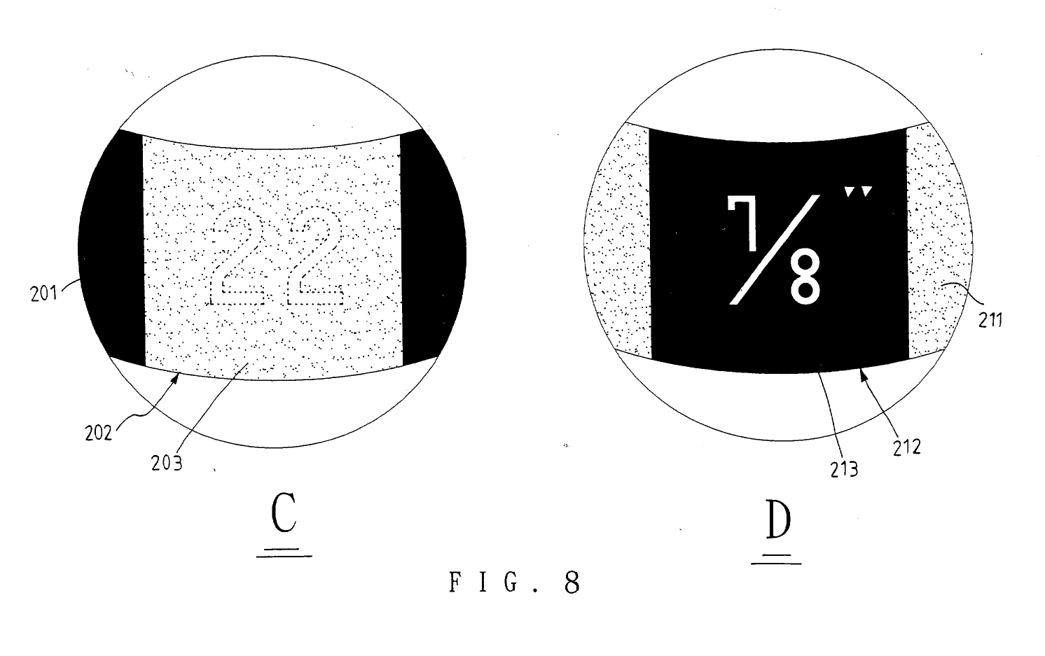

As shown in FIGS. 7 and 8, the present invention comprises a series of sockets 20 (only one of them is shown in the drawing) and a series of sockets 21 (only one of them is shown in the drawing). The sockets 20 are provided in the outer wall with a first identification device 201 and a second identification device 203 which is disposed on an area 202 of the first identification device 201. The first identification device 201 has a color indicative of the metric system by which a specification, such as size “22”, of the sockets 20 is expressed. The second identification device 203 is different in color from the first identification device 201 and is used to form the specification by hollowing instead of printing. The sockets 21 are similarly provided in the outer wall with a first identification device 211 and a second identification device 213 which is disposed in an area 212 of the first identification device 211. The first identification device 211 has a color which is different from the color of the first identification device 201 of the metric system sockets 20 and is indicative of the British system by which a specification, such as size of 7/8 inch, of the sockets 21 is expressed. In light of the first identification devices 201 of the metric system sockets 20 being different in color from the first identification devices 211 of the British system sockets 21, one can reach easily for a metric or British system socket in a situation calling for the use of the metric or British system socket. In addition, the specification of the sockets is conspicuously formed in the second identification device so as to enable a user of the sockets to find easily a desired socket.

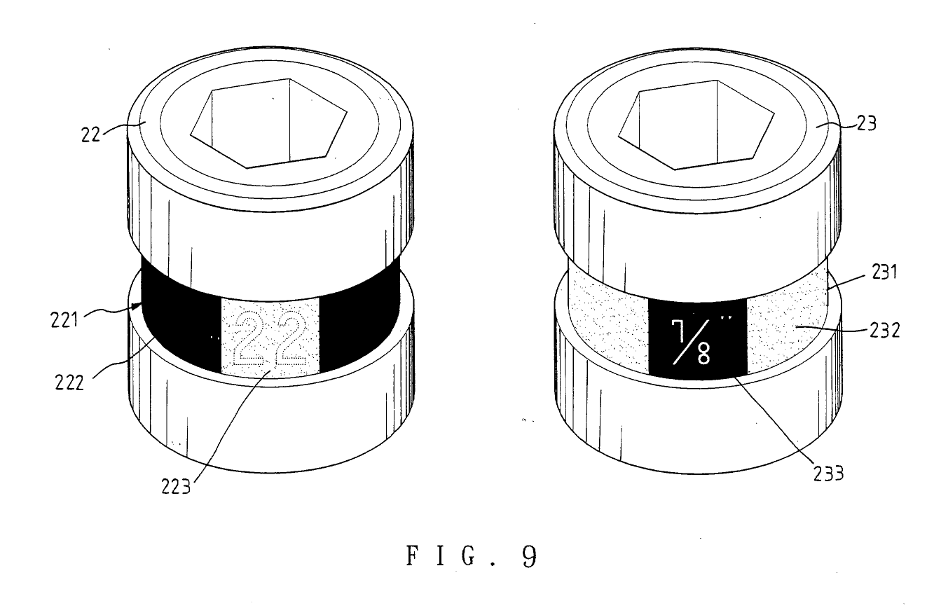

As shown in FIG. 9, a metric system socket 22 is provided with a first identification device 222 and a second identification device 223. The first identification device 222 is disposed in an annular groove 221 of the outer wall of the socket 22. The second identification device 223 is used to form a specification of the socket 22 by hollowing. A British system socket 23 is similarly provided with a first identification device 232 and a second identification device 233. The first identification device 232 is disposed in an annular groove 231 of the outer wall of the British system socket 23.

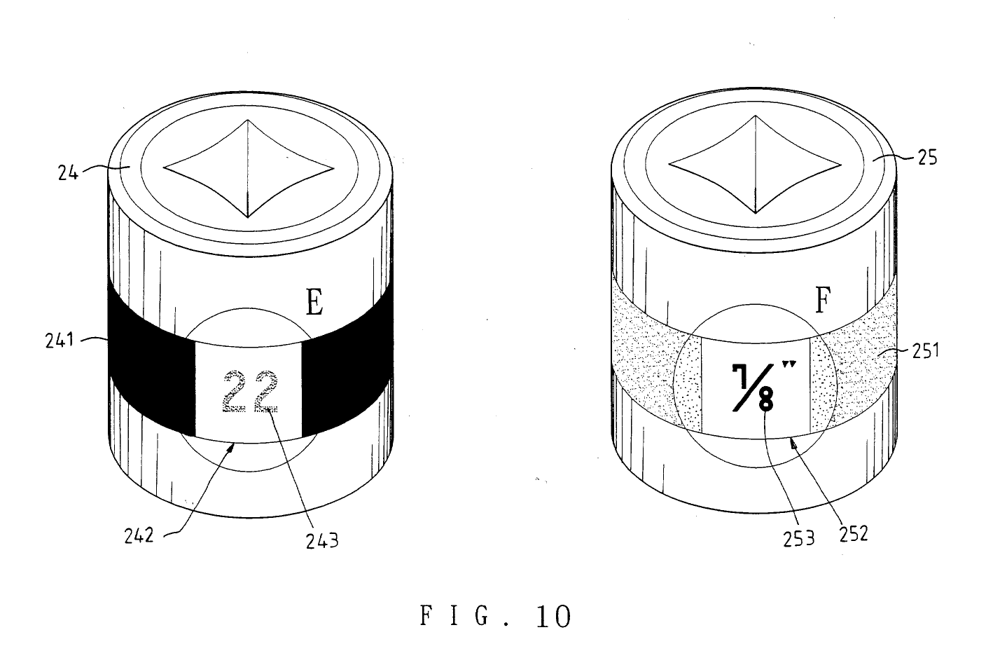

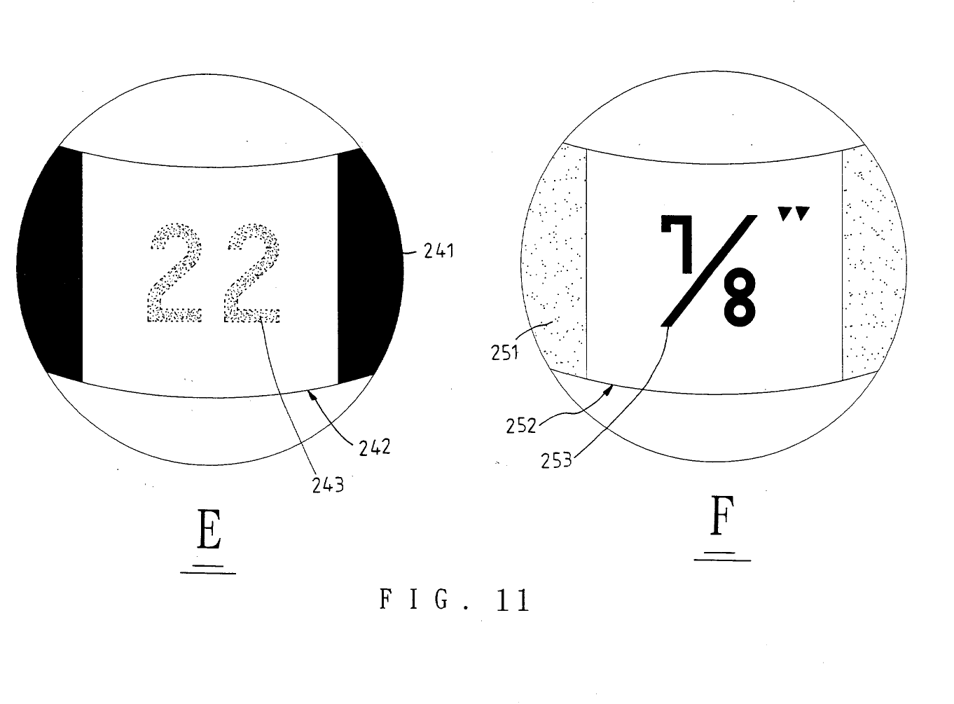

As shown in FIGS. 10 and 11, a metric system socket 24 is provided in the outer wall with a first identification device 241 and a second identification device 243 which is disposed in an area 242 of the first identification device 241. The second identification device 243 is used to form a specification, such as size of 22, of the metric system socket 24 by hollowing the remainder of the second identification device 243. A British system socket 25 is similarly provided in the outer wall with a first identification device 251 and a second identification device 253 which is disposed in an area 252 of the first identification device 251 and is used to form a specification, such as size of 7/8 inch, of the sockets 25 by hollowing the rest of the second identification device 253.

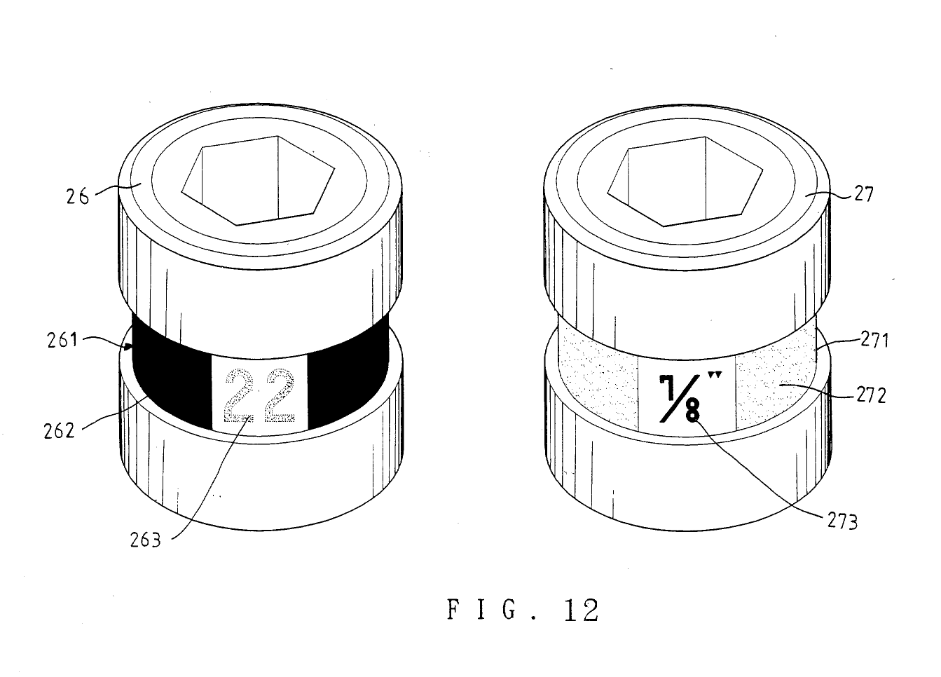

As shown in FIG. 12, a metric system socket 26 is provided in the outer wall with an annular groove 261 in which a first identification device 262 is disposed. A second identification device 263 is disposed on the first identification device 262 and is used to form a specification of the metric system socket 26. A British system socket 27 is similarly provided in the outer wall with an annular groove 271 in which a first identification device 272 is disposed. A second identification device 273 is disposed on the first identification device 272 and is used to form a specification of the British system socket 27.

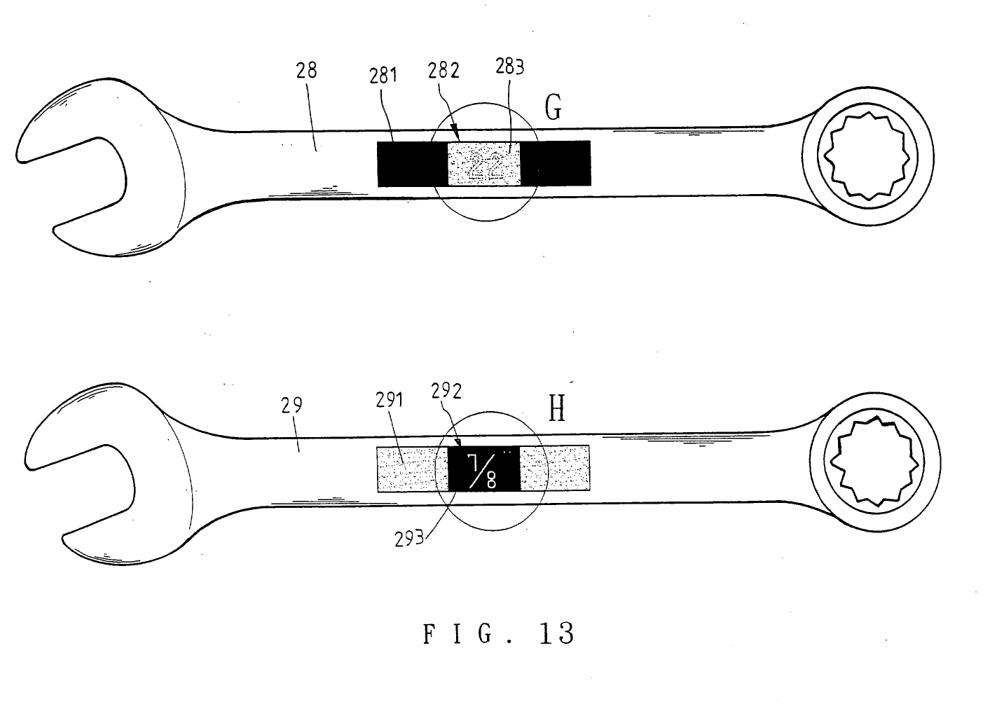

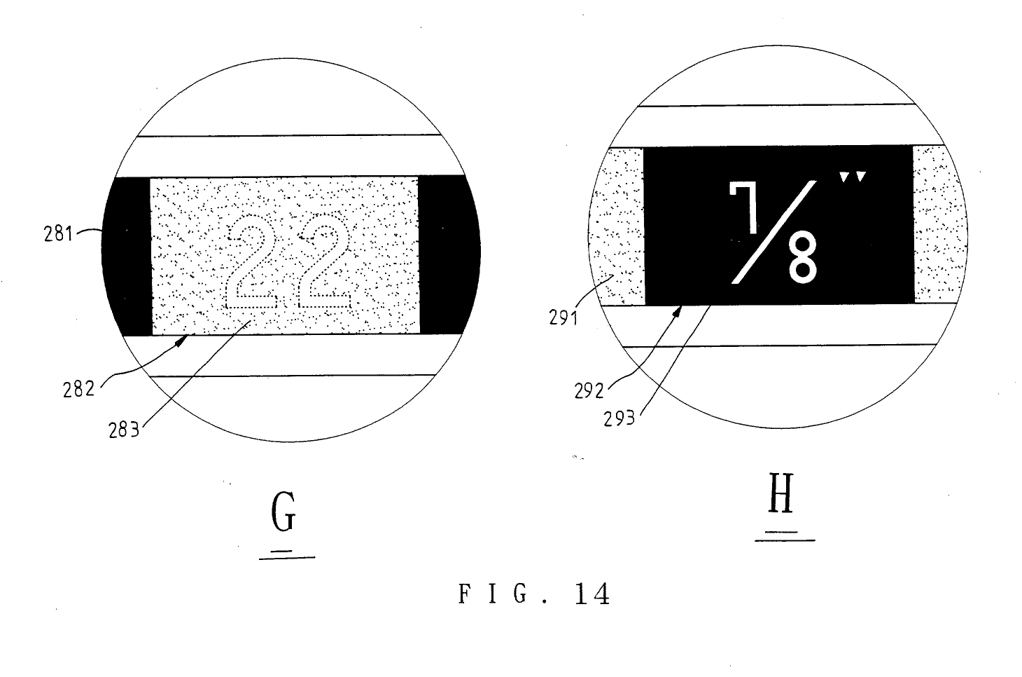

As shown in FIGS. 13 and 14, a metric system double-ended wrench 28 is provided in the outer wall of the handle with a first identification device 281 and a second identification device 283 which is disposed in an area 282 of the first identification device 281 and is used to print thereon a specification, such as size of 22, of the metric system double-ended wrench 28. A British system double-ended wrench 29 is similarly provided in the outer wall of the handle with a first identification device 291 and a second identification device 293 which is disposed in an area 292 of the first identification device 291 and is used to print thereon a specification, such as size of 7/8 inch, of the British system double-ended wrench 29.

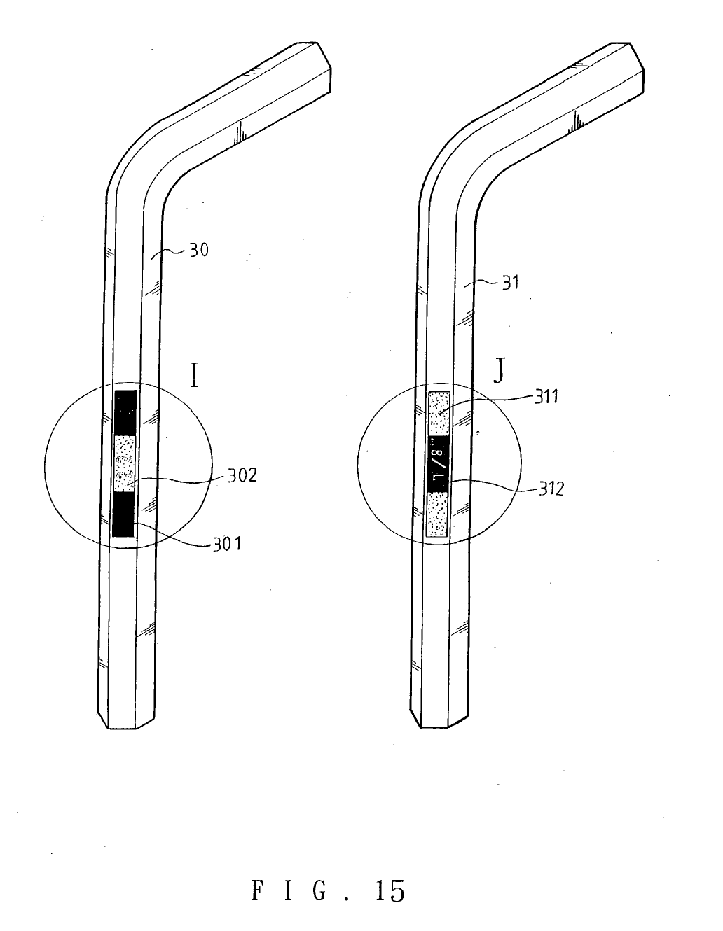

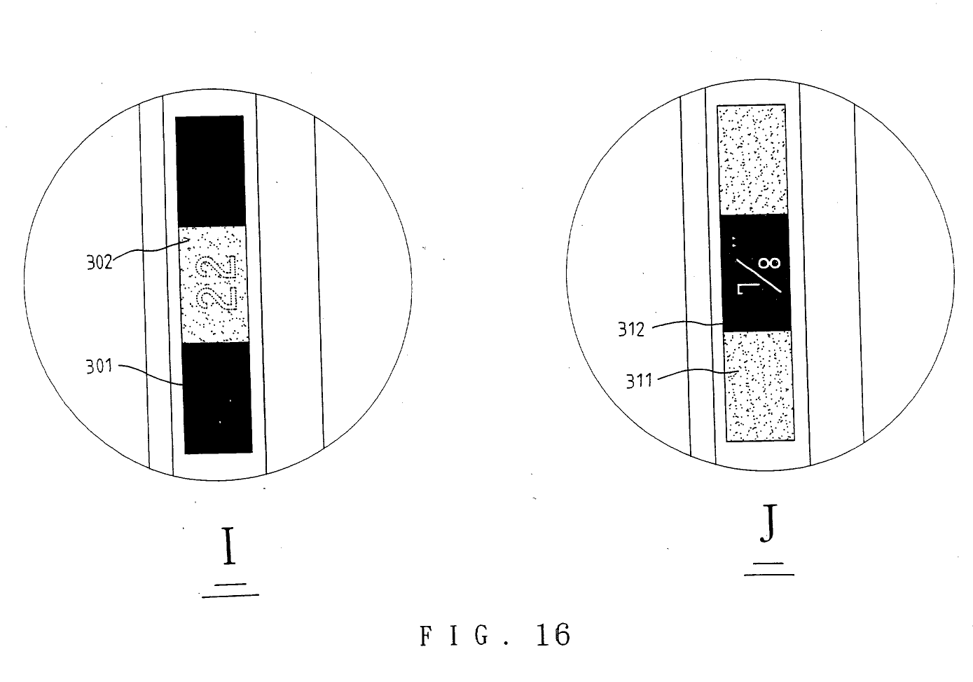

As shown in FIGS. 15 and 16, a metric system Allen wrench (hexagonal wrench) 30 is provided with a first identification device 301 and a second identification device 302 which is disposed on the first identification device 301 for printing thereon a specification, such as size of 22 in the metric system, of the Allen wrench 30. The first identification device 301 is used to associate the Allen wrench 30 with the metric system. A British system Allen wrench 31 is similarly provided with a first identification device 311 and a second identification device 312 which is disposed on the first identification device 311 for printing thereon a specification, such as size of 7/8 inch, of the Allen wrench 31. The first identification device 311 is used to associate the Allen wrench 31 with the British system.

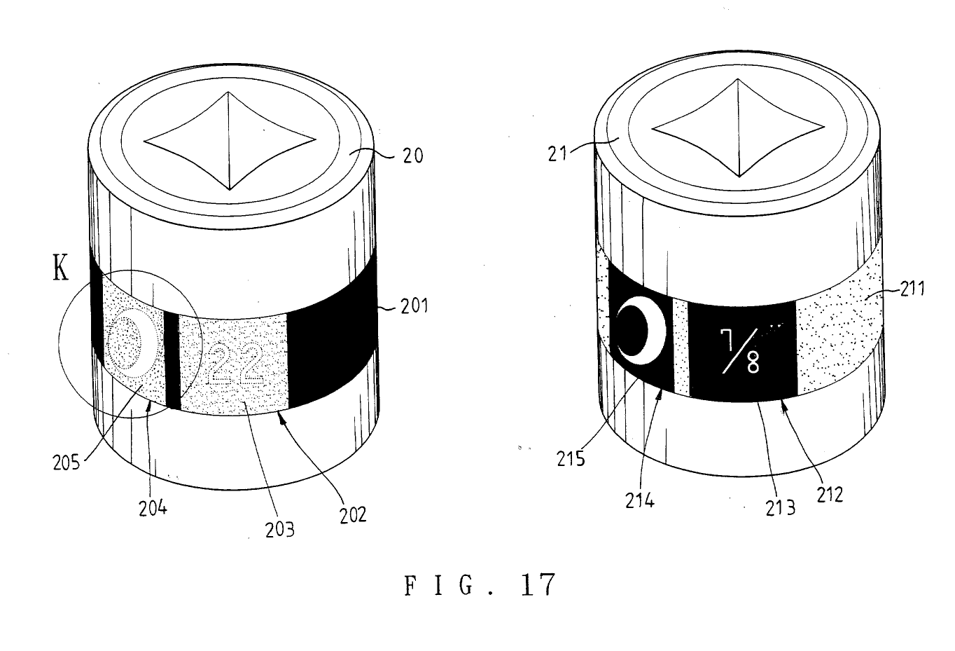

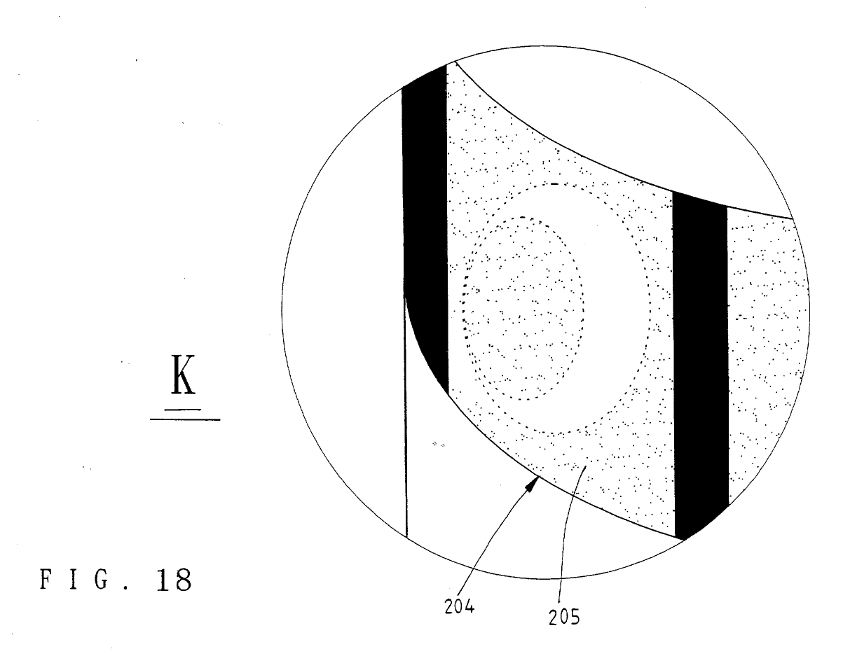

As shown in FIGS. 17 and 18, a metric system socket 20 is provided with a first identification device 201, a second identification device 203 disposed in an area 202 of the first identification device 201, and a third identification device 205 disposed in an area 204 of the first identification device 201. The second identification device 203 is used to print thereon a specification, such as size of 22, of the socket 20. The third identification device 205 is used to mark thereon a logo by printing or by hollowing the third identification device 205. A British system socket 21 is similarly provided with a first identification device 211, a second identification device 213 disposed in an area 212 of the first identification device 211, and a third identification device 215 disposed in an area 214 of the first identification device 211. The second identification device 213 is used to mark thereon a specification, such as size of 7/8 inch, of the socket 21. The third identification device 215 is used to mark thereon a logo by printing, or by hollowing the third identification device 215. The first identification devices 201 and 211 are used to identify the sockets 20 and 21 with the metric system and the British system.

The embodiments of the present invention described above are to be regarded in all respects as being illustrative and nonrestrictive. Accordingly, the present invention may be embodied in other specific forms without deviating from the spirit thereof. The present invention is therefore to be limited only by the scopes of the following claims.

What is claimed is:

1. A tool provided in an outer surface with a first identification device for associating the tool with the metric or British system; wherein said first identification device is provided with a second identification device fastened therewith whereby said second identification device is used to print thereon a specification of the tool.

2. The tool as defined in claim 1, wherein said second identification device is different in color from said first identification device.

3. The tool as defined in claim 1, wherein the specification of the tool is marked on said second identification device by hollowing said second identification device.

4. The tool as defined in claim 1, wherein said first identification device and said second identification device are disposed in a groove which is formed in the outer surface of the tool.

5. The tool as defined in claim 1, wherein the specification of the tool is engraved on the outer surface of said first identification device such that the specification is corresponding in location to said second identification device.

6. The tool as defined in claim 1, wherein the specification of the tool is different in color from said second identification device.

7. The tool as defined in claim 1, wherein said first identification device is further provided with a third identification device fastened therewith whereby said third identification device is used to print thereon a logo of the tool.

8. The tool as defined in claim 7, wherein said first identification device and said third identification device are disposed in a groove which is formed in the outer surface of the tool.

9. The tool as defined in claim 7, wherein the logo of the tool is printed on the outer surface of the tool such that the logo is corresponding in location to said third identification device.
